(19) United States
(12) Patent Application Publication
(10) Pub. No.: US 2017/0196228 A1
(43) Pub. Date: Jul. 13, 2017

(54) INSECT REPELLENT

(71) Applicants: UNIVERSITEIT GENT, Gent (BE); DEVAN CHEMICALS NV, Ronse (BE); CENTRE NATIONAL POUR LA RECHERCHE SCIENTIFIQUE et TECHNIQUE, Rabat (MA)

(72) Inventors: Tarik AANNIZ, Rabat (MA); Mohamed AMAR, Rabat (MA); Lynda BELADJAL, Gent (BE); Johan MERTENS, Gent (BE); Mouna QUADGHIRI, Rabat (MA); Patrice VANDENAELE, Ronse (BE)

(73) Assignees: Universiteit Gent, Gent (BE); Devan Chemicals NV, Ronse (BE); Centre National pour la Recherche Scientifique et Technique, Rabat (MA)

(21) Appl. No.: 15/326,230

(22) PCT Filed: Jul. 16, 2015
(86) PCT No.: PCT/EP2015/066283

§ 371 Date: Jan. 13, 2017

(30) Foreign Application Priority Data
Jul. 17, 2014 (EP) 14177554.4

(51) Int. Cl. A01N 63/02; A01N 31/08; A01N 27/00

(52) U.S. Cl. CPC A01N 63/02; A01N 27/00; A01N 31/08

(57) ABSTRACT

The present invention is based on the fmding that bacterial Volatile Organic Compounds (VOCs) of bacterial strains belonging to the Bacillus genus have an insect repellent activity and can accordingly be used as insect repellents. In particular the VOCs released by blends of such Bacillus strains comprising at least one Bacillus aerius strain, showed a repellent activity against insects like Anopheles gambiae s. s. and Aedes aegypti. It is accordingly an object of the present invention to provide the use of VOCs of bacterial strains belonging to the Bacillus genus as insect repellents. It further provides the use of bacterial strains belonging to the Bacillus genus as insect repellents, in particular the use of Bacillus aerius strains as insect repellents. It also provides the use of blends of bacterial strains belonging to the Bacillus genus as insect repellents, in particular blends comprising at least one Bacillus aerius strain. In a further embodiment, the present invention provides insect repellent compositions comprising blends of bacterial strains belonging to the Bacillus genus, or of the VOCs thereof.

### FIELD OF THE INVENTION

The present invention is based on the finding that bacterial Volatile Organic Compounds (VOCs) of bacterial strains belonging to the Bacillus genus have an insect repellent activity and can accordingly be used as insect repellents. In particular the VOCs released by blends of such Bacillus strains comprising at least one Bacillus aerius strain, showed a repellent activity against insects like Anopheles gambiae s. s. and Aedes aegypti. It is accordingly an object of the present invention to provide the use of VOCs of bacterial strains belonging to the Bacillus genus as insect repellents. It further provides the use of bacterial strains belonging to the Bacillus genus as insect repellents, in particular the use of Bacillus aerius strains as insect repellents. It also provides the use of blends of bacterial strains belonging to the Bacillus genus as insect repellents, in particular blends comprising at least one Bacillus aerius strain. In a further embodiment, the present invention provides insect repellent compositions comprising blends of bacterial strains belonging to the Bacillus genus, or of the VOCs thereof.

### BACKGROUND TO THE INVENTION

Development of insecticide-resistant strains of insects and detection of undesirable chemical residues in the food chain and environmental pollution, have created the need to use safe and efficient approaches against insects.

Nowadays, biocontrol is a quite promising approach to address the aforementioned problems. In the broadest sense biocontrol is defined as “the reduction of the target population by the use of predators, parasites, pathogens, competitors, or toxins from microorganisms” (Woodring and Davidson 1996). One of the approaches is based on the use of natural volatile compounds (VCs) produced by microorganisms and that are biodegradable, that are not leaving toxic residues and displaying as effective control as conventional molecules. Microbial volatile organic compounds (MVOCs) appear as intermediate and end products of various metabolic pathways and belong to numerous structure classes such as mono- and sesquiterpenes alcohols, ketones, lactones, esters or C8 compounds (Schnürer et al., 1999; Korpi et al., 2009). These metabolites have been shown to be involved in different biological processes such as bio-control or communication between microorganisms and their living environment. Recently, in some studies, volatile compounds produced by antagonistic fungi and bacteria have been shown to have potential antifungal activities (Alstrom 2001; Wheatley 2002; Fernando et al. 2005; Kai et al.2006; Zou et al. 2007), and the biocontrol of plant diseases by antifungal volatiles from fungal strains had been carried out under the greenhouse conditions (Mercier and Manker 2005; Koitabashi 2005, Becker et al 2010).

Repellents are the most common means of personal protection against blood seeking arthropods and for the prevention of arthropod-borne disease transmission. Previous work concentrated mainly on simple solutions of tropical repellents and the chemical treatment of clothing to prevent blood-sucking arthropods. Current protection is based on controlled release personal use of controlled-release arthropod repellent formulations, and the impregnation of fabrics with permethrin. The use of topical repellents may still play an important role in the protection of people in areas where no mosquito control methods are carried out. Several repellents have been developed: (benzyl benzoate, butyl ethyl propanediol, dibutylphthalate, dimethyl phthalate, ethyl hexanediol, butopyronoxyl, 2-chlorodiethylbenzamide, acylated1,3 aminopropanolederivates) among which the best known is DEET (Becker et al 2010). It has been reported that Bacillus strains were considered as potential bio-control agents due to their spores, which are commonly resistant to desiccation, heat, U.V. irradiation and organic solvents (Huang et al., 1992; Romero et al., 2007). Bacillus sp. have been reported to inhibit the growth of a number of plant pathogens through antagonism, with multiple modes of action such as the production of antibiotics, enzymes that degrade fungal structural polymers, and antifungal volatiles (Jiang et al., 2001; Pinchuk et al., 2002; Leelasuphakul et al., 2006, Almenar et al. 2007).

The international application WO2011/022790 teaches the application of a mixture consisting of B. subtilis, B. amyloliquefaciens, B. licheniformis, B. pumilis and B. megaterium as insect repellent. It even mentions that these bacteria can be applied both as spores and as living bacteria. It further provides the application of this mixture on textiles, as well as on human or animal skin. There is no explicit mentioning of B. aerius in this specification. In WO2012079073, the Bacillus species are more mentioned as attractants rather than repellents.

### SUMMARY OF THE INVENTION

Based on a screening for insect repellent biocontrol agents, the present invention is based on the finding that the VOCs of Bacillus aerius, have a strong insect repellent activity. In a first aspect the present invention accordingly provides the use of Bacillus aerius, or of volatile organic compounds (VOCs) of Bacillus aerius, as insect repellent.

Per reference to the examples hereinafter, the insect repellent activity of Bacillus aerius is not only observed in isolation, but also when present in bacterial blends comprising Bacillus aerius strains. This in one embodiment the present invention provides the use of blends of bacterial strains comprising at least one Bacillus aerius strain, or of VOCs of said blends as insect repellent. Best results were obtained for blends of Bacillus bacteria. Consequently, in a particular embodiment, the bacterial blends used within the context of the present invention and comprising at least one Bacillus aerius strain, are blends of Bacillus bacteria. Such blends, or the VOCs of such blends can be used as insect repellent.

In a second embodiment, the present invention provides an insect repellent composition comprising Bacillus aerius, or volatile organic compounds (VOCs) of Bacillus aerius. In a further embodiment said insect repellent compositions comprise bacterial blends or VOCs of said blends as described herein, in particular bacterial blends or VOCs of Bacillus bacteria, comprising at least one Bacillus aerius strain.

The VOCs used in the context of the present invention, i.e. as insect repellents are selected from dodecane 5,8-diethyl and benzene 1,3-bis(1,1-dimethyl). Further VOCs from Bacillus aerius with insect repellent activity and herein identified, are dodecane 2,7,10-trimethyl; tetradecane 2,6,10-trimethyl; phenol 3,4-bis(1,1-dimethylethyl); dodecane 2,6,11-trimethyl; heptacosane; and tetracosane. Thus in an embodiment the present invention provides the use of dodecane 5,8-diethyl and/or benzene 1,3-bis(1,1-dimethyl) as insect repellent. In another embodiment the use of dodecane 5,8-dimethyl in combination with one or more of dodecane 2,7,10-trimethyl; tetradecane 2,6,10-trimethyl; phenol 3,4-bis(1,1-dimethylethyl); dodecane 2,6,11-trimethyl; heptacosane; and tetracosane, as insect repellent. In another embodiment the use of dodecane 5,8-diethyl in combination with dodecane 2,7,10-trimethyl; tetradecane 2,6,10-trimethyl; phenol 3,4-bis(1,1-dimethylethyl); dodecane 2,6,11-trimethyl; heptacosane; and tetracosane, as insect repellent. In another embodiment the use of benzene 1,3-bis(1,1-dimethyl) in combination with one or more of dodecane 2,7,10-trimethyl; tetradecane 2,6,10-trimethyl; phenol 3,4-bis(1,1-dimethylethyl); dodecane 2,6,11-trimethyl; heptacosane; and tetracosane, as insect repellent. In another embodiment the use of benzene 1,3-bis(1,1-dimethyl) in combination with dodecane 2,7,10-trimethyl; tetradecane 2,6,10-trimethyl; phenol 3,4-bis(1,1-dimethylethyl); dodecane 2,6,11-trimethyl; heptacosane; and tetracosane, as insect repellent. In another embodiment the use of dodecane 5,8-diethyl and benzene 1,3-bis(1,1-dimethyl) in combination with one or more of dodecane 2,7,10-trimethyl; tetradecane 2,6,10-trimethyl; phenol 3,4-bis(1,1-dimethylethyl); dodecane 2,6,11-trimethyl; heptacosane; and tetracosane, as insect repellent. In another embodiment the use of dodecane 5,8-diethyl and benzene 1,3-bis(1,1-dimethyl) in combination with dodecane 2,7,10-trimethyl; tetradecane 2,6,10-trimethyl; phenol 3,4-bis(1,1-dimethylethyl); dodecane 2,6,11-trimethyl; heptacosane; and tetracosane, as insect repellent. In another embodiment the use of one or more compounds selected from the group consisting of Dodecane,5,8-diethyl, Benzene 1,3-Bis (1,1-diméthyl), Dodecane,2,7,10-triméthyl, Tetradecane 2,6,10-triméthyl, Phenol 3,4-Bis(1,1-dimethylethyl, Dodecane,2,6,11 trimethyl, Heptacosane and Tetracosane, as insect repellent. It is also an object of the present invention to provide the aforementioned VOCs and different combinations thereof in an insect repellent composition.

The insect repellent compositions of the present invention may further comprising other insect repellent agents such as one or more of odorous agents, or oils. Possible insect repellent odorous agents to be used in the compositions of the present invention are selected from the group consisting of DEET (N,N-diethyl-'m-toluamide), para-methane 3,8 diol (PMD), glycerine, lecithin, vanillin and the like. The skilled artisan is well aware of the large number of natural oils with insect repellent activity which can be used in the compositions of the present invention such as for example citronellal, myrcene, limonene, camphor, turmeric oil, coconut oil, geranium oil, soybean oil, peppermint oil, lemongrass oil, pine oil, cedar oil, thyme oil and the like.

As already mentioned herein above, in one embodiment the Bacillus aerius strains are used in bacterial blends of Bacillus bacteria. In one instance the Bacillus bacterial strains are selected from the group consisting of Bacillus amyloliquefaciens, Bacillus licheniformis, Bacillus aerius, Bacillus sonorensis and Bacillus sp. Further characterization of the Bacillus strains is based on 16S ribosomal RNA sequencing, and showed that the Bacillus bacteria used in the blends of the present invention include 10 strains of Bacillus licheniformis, 5 strains of Bacillus aerius, 3 strains of Bacillus sp. , 1 strain of Bacillus amyloliquefaciens and 1 strain of Bacillus sonorensis. The most active blend consist of a blend made up by 2 strains of Bacillus aerius, in combination with 2 strains of Bacillus licheniformis and 1 strain of Bacillus sp. Each of said strains are available from the Bacteria Collection with the “Moroccan Coordinated Collections of Micro-Organisms (CCMM)” as the bacterial strains deposited by M. Amar for original substracts derived from Morocco ‘hot springs’, Morocco ‘desert sand’ and Morocco ‘salt marshe’ on, Apr. 14, 2014. Therefore, in one embodiment of the present invention, the Bacillus aerius strains are selected from the strains deposited with the CCMM collection on April 14, 2014 with the strain identification numbers CCMM-II 3, CCMM-III 1, CCMM-V 3, CCMM-V 4 and CCMM-VI 4; the Bacillus licheniformis strains are selected from the strains deposited with the CCMM collection on Apr. 14, 2014 with the strain identification numbers CCMM-II 1, CCMM-II 2,

CCMM-II 5, CCMM-III 2, CCMM-III 3, CCMM-V 1, CCMM-V 2, CCMM-VI 1, CCMM-VI 3, and CCMM-VI 5; the Bacillus sp. strains are selected from the strains deposited with the CCMM collection on April 14, 2014 with the strain identification numbers CCMM-II 4, CCMM-III 4 and CCMM-V 5; the Bacillus amyloliquefaciens strain consists of the strain deposited with the CCMM collection on Apr. 14, 2014 with the strain identification number CCMM-III 5; and the Bacillus sonorensis strain consists of the strain deposited with the CCMM collection on Apr. 14, 2014 with the strain identification number CCMM-VI 2. In a particular embodiment the Bacillus aerius strain used in the bacterial blends and insect repellent compositions of the present invention is the Bacillus aerius strain deposited with the CCMM collection on Apr. 14, 2014 with the strain identification number CCMM-V 3. This strain has also been deposited with the Belgian Co-ordinated Collection of Micro-Organisms (BCCM) on May 28, 2014 with accession number BCCM/LMG P-28325. Thus alternatively the Bacillus aerius strain used in the bacterial blends and insect repellent compositions of the present invention is the Bacillus aerius strain deposited with the Belgian Co-ordinated Collection of Micro-Organisms (BCCM) on May 28, 2014 with accession number BCCM/LMG P-28325. The CCMM-V3 strain is fast growing and does not require any specific nutrient to produce the repellent volatile compounds. It grows using a wide range of metabolites as source of carbon (see table with Growth characteristics of B. aerius strain BCCM/LMG P-28325 below). The spores produced by this strain are highly resistant to extreme conditions like nutrient starvation and high temperature (spores resisted to a treatment at 350° C.). So, the B. aerius strain could be a good candidate to be encapsulated and integrated in intelligent textiles such as bedding, mattresses, sleeping clothes, textiles of sitting furniture . . . , as an insect repellent agent, in particular as an insect repellent agent, wherein the insect belongs to the order of Diptera, and in particular to the suborder of Nematocera; more in particular wherein the insect belongs to the family of Culicidae; even more in particular wherein the insects are selected from the group consisting of Anopheles gambiae s. s. and Aedes aegypti.

Alternatively, and based on the 16S rRNA sequencing, the different strains can be characterized as a Bacillus strain having a 16 rRNA sequence comprising a sequence having at least 98% sequence identity with SEQ ID NO 1. In a further embodiment the Bacillus aerius strain to be used in the foregoing embodiments of the present invention have a 16S rRNA nucleic acid sequence comprising a sequence having at least 98% sequence identity with SEQ ID NO 1; in particular a 16S rRNA nucleic acid sequence comprising a sequence having at least 99% sequence identity with SEQ ID NO 1; more in particular a 16S rRNA nucleic acid sequence comprising SEQ ID NO 1.

In a further aspect, the present invention provides the use according to any one of the foregoing embodiments, or the insect repellent composition according to any one of the foregoing embodiments, wherein the insect belongs to the order of Diptera, and in particular to the suborder of Nematocera. In a particular embodiment the insect belongs to the family of Culicidae. In a more particular embodiment the insects are selected from the group consisting of Anopheles gambiae s. s. and Aedes aegypti.

Numbered embodiments of the present invention are as follows:
1. Use of Bacillus aerius, or of volatile organic compounds (VOCs) of Bacillus aerius, as insect repellent
2. Use of blends of bacterial strains comprising at least one Bacillus aerius strain, or of VOCs of said blends as insect repellent.
3. The use according to claim 2, wherein the blend of bacterial strains is a blend of Bacillus bacteria.
4. The use according to claim 1 or 2 wherein the VOCs is selected from

Dodecane 5,8-diethyl and/or Benzene 1,3-bis(1,1-dimethyl).
5. The use according to claim 4, wherein said Dodecane 5,8-diethyl or Benzene 1,3-bis(1,1-dimethyl), are further combined with one more VOCs selected from the group consisting of Dodecane 2,7,10-trimethyl; Tetradecane 2,6,10-trimethyl; phenol 3,4-bis(1,1-dimethylethyl); Dodecane 2,6,11-trimethyl; Heptacosane; and Tetracosane.
6. The use according to claim 4, wherein Dodecane 5,8-diethyl is combined with Dodecane 2,7,10-trimethyl; Tetradecane 2,6,10-trimethyl; phenol 3,4-bis(1,1-dimethylethyl); Dodecane 2,6,11-trimethyl; Heptacosane; and Tetracosane.
7. The use according to claim 4, wherein Benzene 1,3-bis(1,1-dimethyl) is combined with Dodecane 2,7,10-trimethyl; Tetradecane 2,6,10-trimethyl; phenol 3,4-bis(1,1-dimethylethyl); Dodecane 2,6,11-trimethyl; Heptacosane; and Tetracosane.
8. The use according according to claim 3, wherein Dodecane 5,8-diethyl and Benzene 1,3-bis(1,1-dimethyl), are further combined with one more VOCs selected from the group consisting of Dodecane 2,7,10-trimethyl; Tetradecane 2,6,10-trimethyl; phenol 3,4-bis(1,1-dimethylethyl); Dodecane 2,6,11-trimethyl; Heptacosane; and Tetracosane.
9. The use according to claim 8, wherein Dodecane 5,8-diethyl and Benzene 1,3-bis(1,1-dimethyl), are combined with Dodecane 2,7,10-trimethyl; Tetradecane 2,6,10-trimethyl; phenol 3,4-bis(1,1-dimethylethyl); Dodecane 2,6,11-trimethyl; Heptacosane; and Tetracosane.
10. The use according to claim 4, wherein the VOCs is selected from one or more compounds selected from the group consisting of Dodecane,5,8-diethyl, Benzene 1,3-Bis (1,1-diméthyl), Dodecane,2,7,10-triméthyl, Tetradecane 2,6,10-triméthyl, Phenol 3,4-Bis(1,1-dimethylethyl, Dodecane,2,6,11 trimethyl, Heptacosane and Tetracosane
11. An insect repellent composition comprising Bacillus aerius, or volatile organic compounds (VOCs) of Bacillus aerius.
12. The insect repellent composition according to claim 11, wherein the composition comprises a blend of bacterial strains comprising at least one Bacillus aerius strain, or VOCs of said blend of bacterial strains comprising at least one Bacillus aerius strain.
13. The insect repellent composition according to claim 11, wherein the VOCs consist of the VOCs and combinations thereof as defined in any one of claims 6 to 9.
14. The insect repellent composition according to any one of claims 11 to 13, wherein the blend of bacterial strains consists of a blend of Bacillus bacteria comprising at least one Bacillus aerius strain.
15. The insect repellent composition according to any one of claims 11 to 14, further comprising one or more of odorous agents, or oils.
16. The insect repellent composition according to claim 15, wherein the odorous agents are selected from the group consisting of DEET (N,N-diethyl-'m-toluamide), para-methane 3,8 diol (PMD), glycerine, lecithin, vanillin and the like.
17. The insect repellent composition according to claim 15, wherein the oils are selected from the group consisting of citronellal, myrcene, limonene, camphor, turmeric oil, coconut oil, geranium oil, soybean oil, peppermint oil, lemongrass oil, pine oil, cedar oil, thyme oil and the like.
18. The use according to claim 3, or the insect repellent composition according to claim 14, wherein the bacterial strains are selected from the group consisting of Bacillus amyloliquefaciens, Bacillus licheniformis, Bacillus aerius, Bacillus sonorensis and Bacillus sp.
19. The use according to any one of the foregoing claims, or the insect repellent composition according to any one of the foregoing claims, wherein the Bacillus aerius strain have a 16S rRNA nucleic acid sequence comprising SEQ ID NO: 1
20. The use according to any one of the foregoing claims, or the insect repellent composition according to any one of the foregoing claims, wherein the insect belongs to the order of Diptera, and in particular to the suborder of Nematocera.
21. The use according to any one of the foregoing claims, or the insect repellent composition according to any one of the foregoing claims, wherein the insect belongs to the family of Culicidae.
22. The use according to any one of the foregoing claims, or the insect repellent composition according to any one of the foregoing claims, wherein the insects are selected from the group consisting of Anopheles gambiae s. s. and Aedes aegypti.
23. The insect repellent composition according to any one of the foregoing claims, wherein the composition is applied to a support, such as textile.
24. The insect repellent composition according to any one of the foregoing claims, wherein the Bacillus aerius or blend of Bacillus bacteria are applied as spores and/or living bacteria to a support, such as textiles.
25. The insect repellent composition according to any one of the foregoing claims, wherein the Bacillus aerius or blend of Bacillus bacteria are applied as spores and/or living bacteria to a support, as an oil emulsion or gel.
26. The insect repellent composition according to any one of the foregoing claims, wherein the Bacillus aerius or blend of Bacillus bacteria are encapsulated in a capsule, said capsule being applied to a support.
27. The insect repellent composition according to claim 25, wherein the capsules are bound to said support.

### BRIEF DESCRIPTION OF THE DRAWINGS

With specific reference now to the figures, it is stressed that the particulars shown are by way of example and for purposes of illustrative discussion of the different embodiments of the present invention only. They are presented in the cause of providing what is believed to be the most useful and readily description of the principles and conceptual aspects of the invention. In this regard no attempt is made to show structural details of the invention in more detail than is necessary for a fundamental understanding of the invention. The description taken with the drawings makes apparent to those skilled in the art how the several forms of the invention may be embodied in practice.

FIG. 1: Schematic representation of the setup used in the repellency bioassay. Pressured air is charcoal-filtered, and passed through the bottle containing the liquid culture (500 ml), creating a bubble of the culture. Produced VOCs are conducted by a second pipe to the flight cage. The out coming are flow will come in contact with the back of a fabric through a funnel so that the air flow containing the VOCs will be better spread over a bigger textile surface. A synthetic blend was used to attract insects to the source of the bacterial VOCs.

FIG. 2: Schematic diagram identifying the different zones for counting the landings of the insects. The circle representing the area of the fabric, the outer square representing the total floor area of the flying chamber and the inner square, an area of said floor just around the fabric. Mosquitoes were left in the flight chamber for 10 min. After 2 minutes of acclimatization time, the number of landings was counted for 8 minutes within three different landing zones (Land IN, Land ON and Land OUT).

FIG. 3: Data related to the repellent effect of the 4 tested blends (II, III, V and VI) against A. aegypti, compared to water and sterile medium.

FIG. 4: Data related to the repellent effect of the individual strains of blend V against A. gambia s.s., compared to water and sterile medium.

FIG. 5: Repellence Index of bacterial blends against An. gambie and Ae. Aegypti. The Repellence Index (RI) was calculated as follows: RI (%)=(number of mosquitoes landing with the test I number of mosquitoes landing with the control)×100.

FIG. 6: Repellence Index of the bacterial strains of blend V against An. gambie and Ae. Aegypti. The Repellence Index (RI) was calculated as follows: RI (%)=(number of mosquitoes landing with the test I number of mosquitoes landing with the control)×100.

### DETAILED DESCRIPTION OF THE INVENTION

The inventors here have found that Bacillus aerius, blends of bacterial strains comprising at least one Bacillus aerius strain, blends of Bacillus strains or volatile organic compounds (VOCs) of Bacillus aerius and of said blends of bacterial strains can be used as insect repellent.

The Bacillus genus refers to a genus of Gram-positive, rodshaped bacteria that are members of the division of Firmicutes. Under stressful environmental conditions, the Bacillus bacteria produce oval endospores that can stay dormant for extended periods. Bacillus bacteria may be characterized and identified based on the nucleotide sequence of their 16S rRNA or a fragment thereof (e.g. approximately a 1000 nt, 1100 nt, 1200 nt, 1300 nt, 1400 nt, or 1500 nt fragment of 16S rRNA or rDNA nucleotide sequence). The 16S ribosomalRNA (or 16S rRNA) is a component of the 30S small subunit of prokaryotic ribosomes. The genes coding for it are referred to as 16S rDNA. Multiple sequences of 16S rRNA can exist within a single bacterium.

Bacillus bacteria may include, but are not limited to B. acidiceler, B. acidicola, B. acidiproducens, B. aeolius, B. aerius, B. aerophilus, B. agaradhaerens, B. aidingensis, B. akibai, B. alcalophilus, B. algicola, B. alkalinitrilicus, B. alkalisediminis, B. alkalitelluris, B. altitudinis, B. alveayuensis, B. amyloliquefaciens, B. anthracis, B. aquimaris, B. arsenious, B. aryabhattai, B. asahii, B. atrophaeus, B. aurantiacus, B. azotoformans, B. badius, B. barbaricus, B. bataviensis, B. beijingensis, B. benzoevorans, B. beveridgei, B. bogoriensis, B. boroniphilus, B. butanolivorans, B. canaveralius, B. carboniphilus, B. cecembensis, B. cellulosilyticus, B. cereus, B. chagannorensis, B. chungangensis, B. cibi, B. circulans, B. clarkii, B. clausii, B. coagulans, B. coahuilensis, B. cohnii, B. decisifrondis, B. decolorationis, B. drentensis, B. farraginis, B. fastidiosus, B. firmus, B. flexus, B. foraminis, B. fordii, B. fortis, B. fumarioli, B. funiculus, B. gala ctosidilyticus, B. galliciensis, B. gelatini, B. gibsonii, B. ginsengi, B. ginsengihumi, B. graminis, B. halmapalus, B. halochares, B. halodurans, B. hemicellulosilyticus, B. herbertsteinensis, B. horikoshi, B. horneckiae, B. horti, B. humi, B. hwajinpoensis, B. idriensis, B. indicus, B. infantis, B. infernus, B. isabeliae, B. isronensis, B. jeotgali, B. koreensis, B. korlensis, B. kribbensis, B. kruiwichiae, B. lehensis, B. lentus, B. licheniformis, B. litoralis, B. locisalis, B. luciferensis, B. luteolus, B. macauensis, B. macyae, B. mannanilyticus, B. marisflavi, B. marmarensis, B. massiliensis, B. megaterium, B. methanolicus, B. methylotrophicus, B. mojavensis, B. muralis, B. murimartini, B. mycoides, B. nanhaiensis, B. nanhaiisediminis, B. nealsonii, B. neizhouensis, B. niabensis, B. niacini, B. novalis, B. oceanisediminis, B. odysseyi, B. okhensis, B. okuhidensis, B. oleronius, B. oshimensis, B. panaciterrae, B. patagoniensis, B. persepolensis, B. plakortidis, B. pocheonensis, B. polygoni, B. pseudoalcaliphilus, B. pseudofirmus, B. pseudomycoides, B. psychrosaccharolyticus, B. pumilus; B. qingdaonensis, B. rigui, B. ruris, B. safensis, B. salarius, B. saliphilus, B. schlegelii, B. selenatarsenatis, B. selenitireducens, B. seohaeanensis. B. shackletonii, B. siamensis, B. simplex, B. siralis, B. smithii, B. soli, B. solisalsi, B. sonorensis, B. sporothermodurans, B. stratosphericus, B. subterraneus, B. subtilis, B. taeansis, B. tequilensis, B. thermantarcticus, B. thermoamylovorans, B. thermocloacae, B. thermolactis, B. thioparans, B. thuringiensis, B. tripoxylicola, B. tusciae, B. vallismortis, B. vedderi, B. vietnamensis, B. vireti, B. wakoensis, B. weihenstephanensis, B. xiaoxiensis, and mixtures or blends thereof.

The term “VOC” refers to an organic compound that normally is gaseous under ambient conditions. VOCs are produced by microorganisms, they are biodegradable and are not leaving toxic residues. They appear as intermediate and end products of various metabolic pathways and belong to numerous structure classes such as mono- and sesquiterpenes alcohols, ketones, lactones, esters or C8 compounds. These metabolites have been shown to be involved in different biological processes such as bio-control or communication between microorganisms and their living environment. Particularly for this invention, VOCs are produced by thermophilic bacteria.

The term “thermophilic bacteria” refers to bacteria that survive at high temperatures (at or over 55° C.). As further detailed in the examples, in this study, several Moroccan biotopes were explored for the isolation of thermophilic bacteria, like hot springs, salt Marsh and desert sand. Sites depth, temperature, salinity and pH were immediately recorded. Collected water samples were filtered through membrane filters. Filters were inoculated into Trypton Soya Aga (TSA) plates or Trypton Soya Broth (TSB) and then, incubated under aerobic conditions at 55° C. for 48 h. After incubation, all colonies obtained were picked and purified by streaking on TSA at least three times. Serial dilutions of sand samples were treated by the same method. Isolated and purified bacterial isolates were stored in TSB containing 15% glycerol at −80° C. for further studies. Cultures of bacteria were grown up in a 1-liter flask containing 500 ml of sterile TSB medium at 55° C. for 48 h to enhance VOCs production. During the studies, 10 blends of thermophilic bacteria (numbered I to X) were used, containing each 5 bacteria with different properties.

To perform screening of VOCs produced by thermophilic bacteria, repellency bio-assays were performed to evaluate host-seeking responses of mosquitoes to VOCs produced by thermophilic bacteria. The term “bio-assay” here refers to a biological assay that is conducted to measure the effects of a substance on a living organism. The term “repellency bio-assay” refers to a biological assay in which the effect of a repellent is measured on a living organism.

As described in the example below, in this study, Anopheles gambiae s.s. and Aedes aegypti were used to evaluate the repellent activity of the Bacillus genus. Anopheles gambiae is a complex of at least seven morphologically indistinguishable species of mosquitoes in the genus Anopheles. The complex includes the most important vectors of malaria in sub-Saharan Africa. This species complex consists of: Anopheles arabiensis, Anopheles bwambae, Anopheles merus, Anopheles melas, Anopheles quadriannulatus and Anopheles gambiae sensu stricto (s.s.). The Aedes aegypti, or yellow fever mosquito, is a mosquito that can spread dengue fever, chikungunya and yellow fever viruses, and other diseases. This mosquito originated in Africa but is now found in tropical and subtropical regions throughout the world.

The repellency bio-assays identified 4 bacterial blends (blend II, III, V, VI) showing repellent activity as compared to the controls. These blends were further deeply studied. First of all, these strains were studied using BOXA1R-PCR fingerprinting. The obtained profiles were analyzed and clustered using BioNumerics v. 6.6. To complete their identification, the representatives of each group were subjected to total 16S rRNA gene sequencing. The resulting sequences were corrected and used in a BLASTN search to find their closest homologues. The 16S rRNA gene sequences were also compared with the prokaryotic Ez-taxon database. The type and reference strains with strong resemblance to the consensus sequences of the different strains were retrieved from the EZ-taxon database, aligned and compared to each other using the BioNumerics v. 6.6. A dendrogram was constructed based on the Pearson correlation. Results showed that the studied strains belonged to Bacillus genus: B. licheniformis (10 strains), B. aerius (5 strains), B. amyloliquefaciens (1 strain), B. sonorensis (1 strain) and Bacillus sp. (3 strains).

As mentioned above, 4 blends (blend II, III, V, VI) showed repellent activity as compared to the controls. As used herein, “Blend II” refers to a mixture of Bacillus bacteria including 3 strains of B. licheniformis (CCMM Strains CCMM-II 1, CCMM-II 2, and CCMM-II 5), 1 strain of B. aerius (CCMM Strain CCMM-II 3) and 1 strain of B. sp. (CCMM Strain CCMM-II 4). As used herein, “blend III” refers to a mixture of Bacillus bacteria including 1 strain of B. aerius (CCMM strain CCMM-III 1), 2 strains of B. licheniformis (CCMM Strains CCMM-III 2 and CCMM-III 3), 1 strain of Bacillus sp. (CCMM Strain CCMM-III 4) and 1 strain of B. amyloliquefaciens (CCMM Strain CCMM-III 5). As used herein, “blend V” refers to a mixture of Bacillus bacteria including 2 strains of B. licheniformis (CCMM Strains CCMM-V 1 and CCMM-V 2), 2 strains of B. aerius (CCMM Strains CCMM-V 3 and CCMM-V 4) and 1 strain of Bacillus sp. (CCMM Strain CCMM-V 5). As used herein, “blend VI” refers to a mixture of Bacillus bacteria including 3 strains of B. licheniformis (CCMM Strains CCMM-VI 1, CCMM-VI 3 and CCMM-VI 5), 1 strain of B. sonorensis (CCMM Strain CCMM-VI 2) and 1 strain of B. aerius (CCMM Strain CCMM-VI 4). Within the foregoing blends, the B. aerius strains showed the strongest repellent activity against Anopheles gambias.s. and Aedes aegypti when compared to the other strains. Thus in a further embodiment the present invention provides blends of Bacillus bacteria comprising B. aerius strains as insect repellents. In particular blends of Bacillus bacteria comprising one or more B. aerius strains selected from CCMM Strains CCMM-II 3, CCMM-III 1, CCMM-V 3, CCMM-V 4, and CCMM-VI 4. More in particular blends of Bacillus bacteria comprising one or more B. aerius strains selected from CCMM-V 3, and CCMM-V 4.

In a particular embodiment the insect repellent composition may include B. aerius or a Bacillus species that is closely related to B. aerius strain deposited with the Belgian Co-ordinated Collection of Micro-Organisms (BCCM) on May 28, 2014 with accession number BCCM/LMG P-28325. A Bacillus species that is closely related to the aforementioned B. aerius strain may be defined as a species having a 16S rRNA sequencing comprising SEQ ID NO: 1 or comprising a 16S rRNA sequence having at least about 98% sequence identity to SEQ ID NO: 1; in particular comprising a 16S rRNA sequence having at least about 99% sequence identity to SEQ ID NO: 1. A Bacillus species that that is closely related to B. aerius strain BCCM/LMG P-28325 may be defined as a B. aerius strain having the following growth characteristics;

Growth characteristics of B. aerius strain BCCM/LMG P-28325
Growth Characteristics Strain BCCM/LMG P-2832S

| | |
|---|---|
| Origin | Merzouga (Morocco |
| No | BCCM/LMG P-28325 |
| Identification | Bacillus aerius (99.13%) |
| Growth Medium | Tryptone Soy Agar (TSA) |
| Optimal growth temperature | 55° C. |
| Phenotypic data: | |
| Colony size | 2 to 3 mm |
| Gram staining | + |
| Shape | Bacilli |
| Color | Beige |
| Aspect | Rough |
| Contour | Irregular |
| Spore forming | + |
| Production of catalase | + |
| Production of oxidase | + |
| Tolerance of NaCl (w/v): | |
| 0.5% | + |
| 10% | + |
| 15% | − |
| Growth at: | |
| 30° C. | + |
| 55° C. | + |
| 60° C. | + |
| 65° C. | + |
| 70° C. | − |
| Resistance of spore to: | |
| 100° C./3 h | + |
| 150° C./1 h | + |
| 350° C./1 min | + |
| Production of: | |
| Amylase | + |
| Cellulase | − |
| Protease | − |
| Lipases | − |
| Carbon source utilization: | |
| Glycerol | + |
| Brythritol | + |
| D-Arabinose | + |
| L-Arabinose | + |
| Ribose | + |
| D-Xylose | + |
| L-Xylose | + |
| Adonitol | + |
| Methyl-D-Xyloside | + |
| Galactose | + |
| Glucose | + |
| Fructose | + |
| Mannose | + |
| Sorbose | + |
| Rhamnose | + |
| Dulcitol | + |
| Inositol | + |
| Mannitol | + |
| Sorbitol | + |
| Methyl-D-Mannoside | + |
| Methyl-D-Glucoside | + |
| Methyl-D-Glucosamine | + |
| Amygdaline | + |
| Arbutine | + |
| Esculine | + |
| Salicine | + |
| Celobiose | + |
| Maltose | + |
| Lactose | + |
| Melibiose | + |
| Saccharose | + |
| Trehalose | + |
| Inulin | + |
| Melezitose | + |
| Raffinose | + |
| Starch | + |
| Glycogen | + |
| Xylitol | + |
| Gentiobiose | + |
| D-Turanose | − |
| D_Lyxose | + |
| D-Tagatose | + |
| D-Fucose | + |
| D-Arabitol | + |
| L-Arabitol | + |
| Gluconate | − |
| 2-keto-Gluconate | − |
| 5-keto-Gluconate | + |

Insect repellents are the most common means of personal protection against blood seeking arthropods and for the prevention of arthropod-borne disease transmission. The presently disclosed insect repellent composition may be utilized to repel insects belonging to the order of the Diptera, and in particular to the suborder of Nematocera, and to the family of Culicidae. The family of Culicidae is a family of small, midge-like flies, also said mosquitoes.

The presently disclosed insect repellent composition further comprises one or more odorous agents, or oils. The odorous agents will be selected from the group consisting of DEET (N,N-diethyl-3-methylbenzamide), para-methane 3,8 diol (PMD), glycerine, lecithin, vanillin and the like. DEET is a yellow oil that serves as an insect repellent in that mosquitoes intensely dislike the smell of the chemical repellent DEET. DEET activates a type of olfactory receptor neuron in special antennal sensilla of mosquitoes. Moreover, DEET has a strong repellent activity in the absence of body odor attractants such as 1-octen-3-ol, lactic acid, or carbone dioxide. PMD is an active ingredient used in insect repellents as well. PMD is found in small quantities in the essential oil from the leaves of Eucalyptus citriodora. Glycerol (or glycerine, glycerin) is a simple polyol (sugar alcohol) compound. It is a colorless, odorless, viscous liquid that is widely used in pharmaceutical formulations. Lecithin is a generic term to designate any group of yellow-brownish fatty substances occurring in animal and plant tissues composed of phosphoric acid, choline, fatty acids, glycerol, glycolipids, triglycerides, and phospholipids (e.g., phosphatidylcholine, phosphatidylethanolamine, and phosphatidylinositol). Lecithin can easily be extracted chemically (using hexane, ethanol, acetone, petroleum ether, benzene, etc.) or mechanically. It is usually available from sources such as soybeans, eggs, milk, marine sources, rapeseed, cottonseed, and sunflower. Vanillin, also known as 4-Hydroxy-3-methoxybenzaldehyde is the primary component of the extract of the vanilla bean. In addition to its major use as flavouring agent, vanillin is also used in the fragrance industry, in perfumes, and to mask unpleasant odors or tastes in medicines, livestock fodder, and cleaning products.

The insect repellent compositions of the present invention may further comprise natural oil. A large number of natural oils, for example citronellal, myrcene, camphor, turmeric oil, geranium oil, soybean ail, peppermint oil, lemongrass oil, pine oil, cedar oil, thyme oil and the like will be used. Citronella is one of the most widely used natural repellents. Initially, citronella, which contains citronellal, citronellol, geraniol, citral.

In another possible embodiment, the agent of invention can be formulated in the form of a liquid, gel or solid, provided that the attractant compounds can vaporize from said formulation. Any solvent or other ingredient can be used in the formulation as long as it does not harm the evaporation of the attractant and/or the attracting effect. Such solvents may, for instance, be water, ethanol, butanol, methanol, benzene and phenol. Additionally surface active compounds may be added. Alternatively, the agent of the invention may be admixed with CO₂ and used as a spray. The use of CO₂ in this respect is advantageous, since this gas is a kairomone which is active over a relatively large distance. CO₂ is said to activate the insects to start flying against the wind and thus increasing the chance to be attracted by the agent of the invention. Of course, an insect repellent may be added to the spray.

In another possible embodiment, the insect repellent can be applied to a support and they will have a slower, but longer-lasting effect against mosquitos. When applying the insect repellent composition, a dispenser such as an atomiser can be used, or they can be applied by means of impregnation or as a coating on the support. Textiles are understood to mean primarily mattresses, bedding, sheets, pillows, but also clothing and related items such as sleeping cloths and handkerchiefs. The textiles can be either woven or non-woven. They are then treated with the insect repellent in such a manner that it penetrates the fabric or the fibres of the textile.

Furthermore, the insect repellent composition can also be applied in textiles of sitting furniture, such as sofas in living rooms or seats in transport means, as well as corresponding seat covers. Also the mixture can be applied to human skin or animal fur to repel mosquitos. The non-pathogenic bacteria can be applied both as spores and as living bacteria Mosquitoes are repelled from the location where the mixture of non-pathogenic bacteria is applied to a support, such as textiles, or sprayed by means of a dispenser. Longer-lasting effects can be achieved if the mixture of nonpathogenic bacteria, occurring both as spores and as living bacteria, is applied to a support. In addition, the high reproductivity of the bacteria ensures a long-lasting effect. Since the mixture of non-pathogenic bacteria is odourless and does not contain any harmful chemicals, it does not cause any additional annoying effects, nor irritation of the airways or skin, which is a second advantage. The non-pathogenic bacteria of the Bacillus genus can be applied to a variety of supports, such as different textile fibres. This allows the mixture to be applied to both bedding and clothing or related textiles. The mixture can also be applied to textiles of sitting furniture or seats in transport means, such as car seats or corresponding seat covers. The non-pathogenic bacteria of the Bacillus genus can be applied both as spores and as living bacteria, depending on the intended purpose. In the former case, a quick action (sporadic) is intended, while in the latter case a rather slow (permanent), but mainly long-lasting, effect is achieved. Using a dispenser, the non-pathogenic bacteria are applied to the desired location or support. The non-pathogenic bacteria may be applied as an oil emulsion or gel. In another possible embodiment the insect repellent compositions are encapsulated in a capsule, consisting of a biopolymer or synthetic polymer. In this form, the blends of bacteria and/or VOCs can be applied to a support and they will have a slower, but longer-lasting effect against mosquitoes. Examples of such encapsulated application of insecticides to different substrates are known to the skilled artisan and can for example be found in the following patent publications WO2006117702, PT102796 and WO2005018795.

As will be further detailed in the experimental part hereinafter, further to the identification of the insect repellent activity of the B. aerius strain and the aforementioned bacterial blends, it has also been an object of the present invention to determine the VOCs responsible for said insect repellent activity. Gas chromatographic analysis of the VOCs released by B. aerius strain BCCM/LMG P-28325, revealed dodecane 5,8-dimethyl and benzene 1,3-bis(1,1-dimethyl) as VOCs with a previously unrecognized utility as insect repellents. Further VOCs retrieved from B. aerius strain BCCM/LMG P-28325 include dodecane 2,7,10-trimethyl; tetradecane 2,6,10-trimethyl; phenol 3,4-bis(1,1-dimethyl), dodecane 2,6,11 trimethyl, heptacosane and tetracosane. It is accordingly an object of the present invention to provide the use of each of said B. aerius derived VOCs either alone or in combination as insect repellents. It is in particular directed to the use of dodecane 5,8-dimethyl and/or benzene 1,3-bis(1,1-dimethyl) as insect repellent, including insect repellent compositions comprising them.

The invention will be illustrated by the following examples, which are not meant to limit the invention in any way.

### EXAMPLES

### Material and Methods

### Insects Tests

Anopheles gambiae s.s. and Aedes aegypti used in this study have been cultured in the laboratory of entomology, Wageningen University. They received blood meals from a human arm twice a week. Adults were maintained in 30-cm cubic gauze-covered cages in a climate-controlled chamber (27±1° C., 80±5% RH, LD 12:12).

### Bacterial Blends

During these studies, we used 10 blends of thermophilic bacteria (numbered from I to X) containing each 5 bacteria with different properties. Cultures were grown in a 1-liter flask containing 500 ml of sterile TSB medium at 55° C. for 48 h to enhance the VOCs production.

### Repellency Bioassays

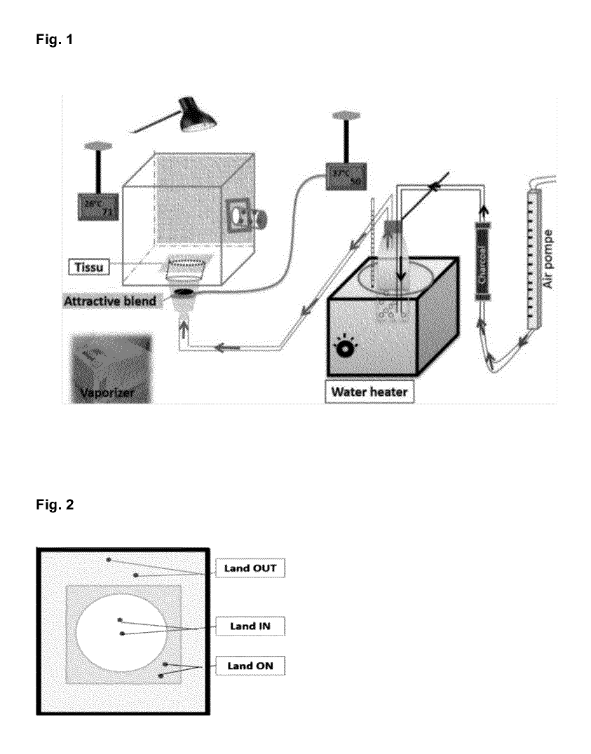

The setup used to evaluate host-seeking responses of mosquitoes to VOCs produced by thermophilic bacteria is shown in FIG. 1. Pressurized air was charcoal-filtered, and passed through the bottle containing the liquid culture (500 ml), creating a bubbling of the culture. Produced VOCs are conducted by a second pipe to the flight cage. The out coming air flow will come in contact with the back of a fabric through a funnel so that the air flow containing the volatiles will be better spread over a bigger textile surface. A synthetic blend was used to attract insects to the source of the bacterial VOCs.

For each test, 10 female mosquitoes of 6-7 days old, which had never received a blood meal, were selected 14-18 h before the experiment and placed in a cylindrical release cage (d=8, h=10 cm) with access to tap water from damp cotton wool. The experiments were performed during the last 4 h of the scotophase, when insects are known to be highly responsive to odors (Maxwell et al. 1998, Killeen et al. 2006). The experimental room was maintained at a temperature of 26.7±0.8° C. and a relative humidity of 64.5±3.5%.

Mosquitoes were left in the flight chamber for 10 min. After 2 minutes of acclimatization time, the number of landings was counted for 8 minutes within three different areas (Land IN, Land ON and Land OUT) (FIG. 2). A landing was defined as the total period for which a mosquito maintained contact with the landing platform. Walking/hopping around on the landing plateau as well as short (<1 sec.) take offs immediately followed by landing again were included in one landing. A new landing was recorded when a mosquito had left the plateau for more than one sec. before landing again. Landings shorter than one sec. during which no probing took place were ignored.

All the experiments were repeated 8 times (2 times/day). As blank we used the distillated water and sterile broth media. At the end of each experiment, mosquitoes were removed with a vacuum cleaner. Each trial started with a fresh batch of mosquitoes, clean trapping devices, and new stimuli.

The active blends against An. gambiae s. s. were also tested against A. aegypti. Furthermore, the 5 strains which make up the most active blend against An. gambiae s. s. were tested separately in order to determine the nature of the repellent activity (individual effect or synergy).

### Identification of Characterization of the Active Strains

Four blends (blend II, III, V and VI), containing 20 strains (table 1), showing repellent activity, as compared to the controls were deeply studied, using a polyphasic approach.

First of all, these strains were studied using BOXA1R-PCR fingerprinting. The obtained profiles were analyzed and clustered using BioNumerics v. 6.6. To complete their identification, the representatives of each group were subjected to total 16S rRNA gene sequencing.

The resulting sequences were corrected and used in a BLASTN search to find their closest homologues.The16S rRNA gene sequences were also compared with the prokaryotic Ez-taxon database (Chun, J et al. 2007). The type and reference strains with strong resemblance to the consensus sequences of the different strains were retrieved from the EZ-taxon database, aligned and compared to each other using the BioNumerics v. 6.6. A dendrogram was constructed based on the Pearson correlation.

### RESULTS

### Repellency Test

In this study, we tested the repellent activity against Anopheles gambiae s. s. using 10 blends of bacteria (I to X) containing 5 strains each. As negative control, we used sterile water and culture medium. An attractive blend made by Wageningen University was used as negative control. The results of the average number of landing (8 repetitions) are shown in table 2. Interpretation of results was based on the comparison of the obtained averages with the controls values.

Both treatment and testing day showed a significant effect on the number of landings. Room temperature, relative humidity and the temperature of the airflow had no significant effect. Based on the comparison of the obtained values with those of the control, we consider only the values corresponding to Land IN, Land TOT and % Land IN/TOT.

The total landings (Land TOT) showed the potential influence of bacterial VOCs on the insect behavior inside the cage, when compared to the average values of the control (Sterile culture media). As evident from the foregoing table, blends (I, VI, IX and X) with values close to the medium could be considered as blends with no effect on the insect behavior. Blends (VII and VIII) showed increased values as compared to the medium. They could have an attractive effect, but this should be deeply investigated. Blends (II, III, IV and V) showed decreased values as compared to the medium. They could be considered as repellent blends.

The average values of the number of landings in the center (Land IN) revealed an influence of the bacterial VOCs produced on insect behavior. In the present assay, the Land IN parameter is considered as the most important parameter showing the direct impact of bacterial VOCs on the insect behavior. As evident from the foregoing table, blends (I, IV, VII, VIII, IX and X) with values close to the sterile medium. They could be considered as blends with no effect on the insect behavior. Blends (II, III, V and VI) with decreased values as compared to the medium. They could be considered as repellent blends.

A final parameter considered in the present study, is the calculation of % Land IN/TOT. In comparison to the control, it gives the real percentage of landing in the center of the fabric where the concentration of bacterial volatiles was higher. Where for blends II, II and IV no differences were observed, blends (V, VI and VII) with significantly decreased values as compared to those of the sterile medium. They could be considered as repellent blends.

The analysis of the three parameters showed that blends II, III, IV, V and VI showed repellency against An. gambiae s.s., with blends II, III, V and VI reoccurring in two of the three parameters. Moreover, the blend V could be considered as the most repellent against the tested insect.

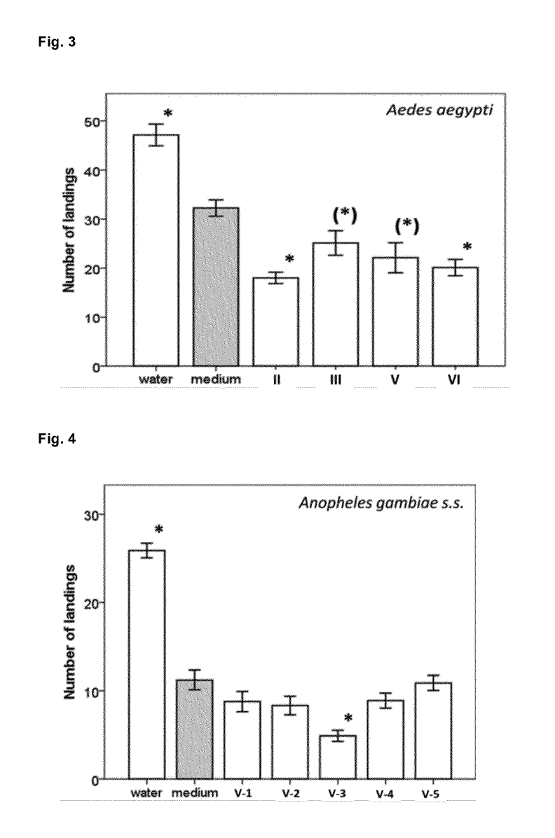

In a subsequent test, the reoccurring blends II, III, V and VI were retested against A. aegypti. Data related to the repellent effect of the 4 tested blends (II, III, V and VI) against A. aegypti are shown in FIG. 3. All blends showed significantly decreased values as compared to the sterile medium control, blends II and VI being the most outspoken.

To further analyze the observed repellency, the individual strains of blend V, were subsequently tested against Anopheles gambiae s. s. The results are provided in FIG. 4, and allow us to conclude that the observed activity is mainly due to strain CCMM-V3, present within said blend.

### Bacterial Strain Characterization

The identification of the studied strains using 16S rRNA gene sequencing is shown in the table 3. Our results showed that the studied strains belonged to Bacillus genus: B. licheniformis (10 strains), B. aerius (5 strains), B. amyloliquefaciens (1 strain), B. sonorensis (1 strain) and Bacillus sp. (3 strains).

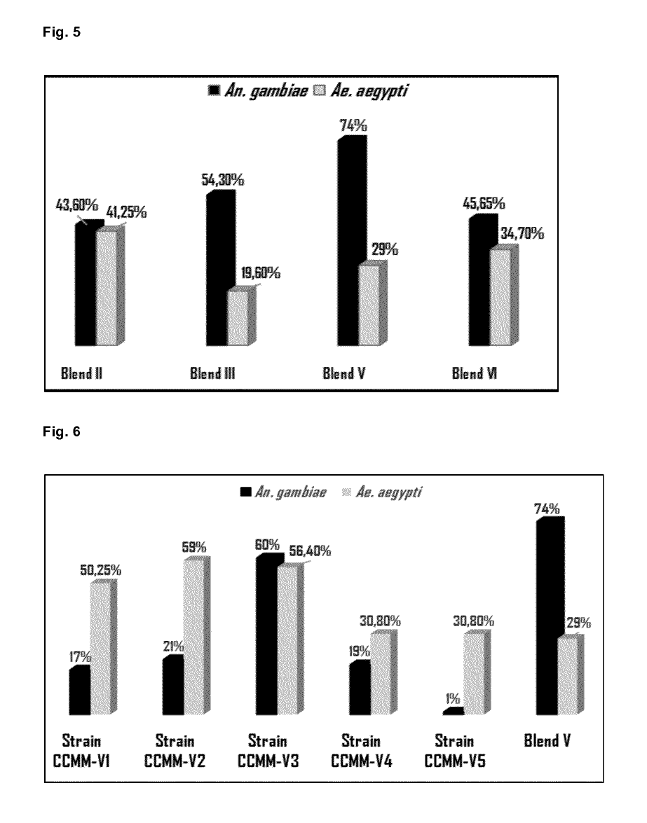

The analysis of the results revealed that out of the 10 tested blends, 4 blends (II, III, V and VI) produced VOCs with potential repellent activity against Anopheles gambiae s. s. and Aedes aegypti. The four blends (II, III, V and VI) showing a high repellence against An. gambiae were tested against Ae. aegypti. The results showed that the blend II has significantly reduced the number of landing by 41% and the blend VI reduced the number of landing by 34%. The blends III and V showed a weak reduction between 19% and 29% respectively (FIG. 5). Blend V being the most active against Anopheles gambiae s. s. was further tested for the individual activity of the 5 bacteria making up this blend. Among the blend V (most active against Anopheles gambiae s. s.) the strain CCMM-V3 identified as Bacillus aerius was significantly active as compared to the 4 other strains (CCMM-V1, CCMM-V2, CCMM-V4 and CCMM-V5) making up this blend. The results showed that the CCMM-V3 strain has significantly reduced the number of An. gambiae s.s. landing by 60% of reduction as compared to TSB medium. The 3 strains CCMM-V1, CCMM-V2 and CCMM-V4 showed only a weak reduction (17 to 21%) while the CCMM-V5 strain has no effect (FIG. 6). Moreover, CCMM-V1, CCMM-V2 and CCMM-V3 strains have significantly reduced the number of Ae. aegypti landing by 50%, 59% and 56% respectively. The CCMM-V4 and CCMM-V5 showed only a weak reduction (30.38%) (FIG. 6).

Among the 5 bacteria tested separately, CCMM-V3 strain is considered as the highest host-seeking female mosquito repellent (60% of reduction against An. gambiae and 56.4% against Ae. aegypti). The high repellent activity of the blend V against An. gambiae (reduction of 74%) could be explained by the strongest effect of the CCMM-V3 strain whish reduced individually the number of landing of this mosquito by 60%.

### Characterization of the VOCs of B. aerius strain CCMM-V 3

The same set-up as used in the insect repellency test was used in collection the material for the gas chromatographic analysis of the VOCs produced by a liquid culture (500 ml ) of B. aerius strain CCMM-V 3.

Helium was used as carrier gas in the chromatographic separation on a nonpolar fused silica capillary column (Length: 30 m, Internal Diameter: 0,25 mm, Film Thickness: 0,25 μm) coated with a 5% diphenyl/95% Dimethyl Polysiloxane stationary phase.

The VOCs were separated using the following temperature gradient;

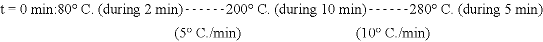

Using the aforementioned protocol the following VOCs (Table 4) were identified in a sample collected from a culture of B. aerius strain CCMM-V 3.

Six of those 8 compounds were also detected in the GC-MS chromatogram of the TSB medium i.e., Dodecane,5,8-diethyl, Benzene 1,3-Bis (1,1-diméthyl), Tetradecane 2, 6, 10-triméthyl, Phenol 3, 4-Bis (1, 1-dimethylethyl) and Dodecane, 2, 6, 11 trimethyl (FIG. 7b). These 6 compounds could be responsible of the weak repellence observed with the TSB medium as compared to sterile water. Nevertheless, Heptacosane and Tetracosane were detected only in the CCMM-V3 GC-MS chromatogram and could be responsible of the strongest repellent effect of this strain.

It is accordingly an object of the present invention to provide a mosquito repellent comprising one or more compounds selected from the group consisting of Dodecane,5,8-diethyl, Benzene 1,3-Bis (1,1-diméthyl), Dodecane,2,7,10-triméthyl, Tetradecane 2,6,10-triméthyl, Phenol 3,4-Bis(1,1-dimethylethyl, Dodecane,2,6,11 trimethyl, Heptacosane and Tetracosane. These volatiles could be used to develop of a new bio-spray.

### TO CONCLUDE

In the present invention, it was proved that volatile compounds produced by a Bacillus aerius (CCMM-V3) repel harmful mosquitoes mainly An. gambiae (60% of reduction of landing) and Aedes aegypti (56% of reduction of landing). According to its characteristics i.e. production of repellent volatile compounds, growth at high temperature (up to 65° C.), production of highly resistant spores (resist up to 350° C.), the B. aerius CCMM-V3 strain could be considered as a good candidate to be integrated in intelligent textiles (bedding, mattresses, sleeping clothes, textiles of sitting furniture . . . ) with the aim to repel the two studied mosquito disease vectors. The CCMM-V3 strain could also be integrated in a push-pull strategy. Mosquitoes will be repelled (push) away from the strain CCMM-V3 resource. Then, they will be attracted (pull) to other areas where they will be concentrated and eliminated. Furthermore, a new mosquito repellent spray could be developed comprising volatile compounds produced by this strain i.e., Dodecane,5,8-diethyl, Benzene 1,3-Bis (1,1-diméthyl), Dodecane,2,7,10-triméthyl, Tetradecane 2,6,10-triméthyl, Phenol 3,4-Bis(1,1-dimethylethyl, Dodecane,2,6,11 trimethyl, Heptacosane and Tetracosane.

1.-4. (canceled)

5. An insect repellent composition comprising Bacillus aerius, or volatile organic compounds (VOCs) of Bacillus aerius.

6. The insect repellent composition according to claim 5, wherein the composition comprises a blend of bacterial strains comprising at least one Bacillus aerius strain, or VOCs of said blend of bacterial strains comprising at least one Bacillus aerius strain.

7. The insect repellent composition according to claim 5, wherein the VOCs is selected from Dodecane 5,8-diethyl and/or Benzene 1,3-bis(1,1-dimethyl), and wherein the Dodecane 5,8-diethyl and/or Benzene 1,3-bis(1,1-dimethyl) are optionally further combined with one more VOCs selected from the group consisting of Dodecane 2,7,10-trimethyl;
Tetradecane 2,6,10-trimethyl; phenol 3,4-bis(1,1-dimethylethyl); Dodecane 2,6,11-trimethyl;
Heptacosane; and Tetracosane.

8. The insect repellent composition according to claim 5, further comprising one or more of odorous agents, or oils.

9. The insect repellent composition according to claim 8, wherein the odorous agents are selected from the group consisting of DEET (N,N-diethyl-'m-toluamide), para-methane 3,8 diol (PMD), glycerine, lecithin, and vanillin.

10. The insect repellent composition according to claim 8, wherein the oils are selected from the group consisting of citronellal, myrcene, limonene, camphor, turmeric oil, coconut oil, geranium oil, soybean oil, peppermint oil, lemongrass oil, pine oil, cedar oil, and thyme oil.

11. The insect repellent composition according to claim 6, wherein the bacterial strains are selected from the group consisting of Bacillus amyloliquefaciens, Bacillus licheniformis, Bacillus aerius, Bacillus sonorensi and Bacillus sp.

12. The insect repellent composition according to claim 5, wherein the Bacillus aerius strain have a 16S rRNA nucleic acid sequence comprising SEQ ID NO: 1.

13.-15. (canceled)

16. A method for repelling an insect, the method comprising:
applying an insect repellent composition comprising Bacillus aerius, or volatile organic compounds (VOCs) of Bacillus aerius to a support.

17. The method of claim 16, wherein the composition comprises a blend of bacterial strains comprising at least one Bacillus aerius strain, or VOCs of said blend of bacterial strains comprising at least one Bacillus aerius strain.

18. The method of claim 16, wherein the VOCs is selected from Dodecane 5,8-diethyl and/or Benzene 1,3-bis(1,1-dimethyl).

19. The method of claim 18, wherein said Dodecane 5,8-diethyl and/or Benzene 1,3-bis(1,1-dimethyl), are further combined with one more VOCs selected from the group consisting of Dodecane 2,7,10-trimethyl; Tetradecane 2,6,10-trimethyl; phenol 3,4-bis(1,1-dimethylethyl);
Dodecane 2,6,11-trimethyl; Heptacosane; and Tetracosane.

20. The method of claim 16, wherein the insect belongs to the order of Diptera.

21. The method of claim 16, wherein the insect is selected from the group consisting of Anopheles gambiae s. s. and Aedes aegypti.


SEQUENCE LISTING (1 sequence)

SEQ ID NO: 1 - RNA, 1508 nt, Bacillus aerius
  source 1..1508: /organism=“Bacillus aerius” /note=“16S gene sequence” /mol_type=“unassigned RNA”
aagagtttttaattctggttcaggacgaacgctggcggcgtgcttaatccatgcaagtcgagcggaccgacgggagcttgctcccttaggtcagcggcggacgggtgagtaacacgtgggtaacctccctgtaagactgggataattccgggaaaccggggttaataccggatgcttgattgaaccccatggttcaatcataaaaggtggcttttagctaccacttacagatggacccgcggcgcattagctagttggtgaggtaacggctcaccaaggcgacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaaactctgttgttagggaagaacaagtaccgttcgaatagggcggcaccttgacggtacctaaccagaaagccacggctaactacgtgccagcagccgcggtaatacgtaggtggcaagcgttgtccggaattattgggcgtaaagcgcgcgcaggcggtttcttaagtctgatgtgaaagcccccggctcaaccggggagggtcattggaaactggggaacttgagtgcagaagaggagagtggaattccacgtgtagcggtgaaatgcgtagagatgtggaggaacaccagtggcgaaggcgactctctggtctgtaactgacgctgaggcgcgaaagcgtggggagcgaacaggattagataccctggtagtccacgccgtaaacgatgagtgctaagtgttagagggtttccgccctttagtgctgcagcaaacgcattaagcactccgcctggggagtacggtcgcaagactgaactcaaaggaattgacgggggcccgcacaagcggtggagcatgtggtttaattcgaagcaacgccaagaaccttaccaggtcttgacatcctctgacaaccctagagatagggcttccccttcgggggcagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatgggcagaacaaagggcagcgaagccgcgaggctaagccaatcccacaaatctgttctcagttcggatcgcagtctgcaactcgactgcgtgaagctggaatcgctagtaatcgcggatcagcatgccgcggtgaatacgttcccgggccttgtacacaccgcccgtcacaccacgagagtttgtaacacccgaagtcggtgaggtaaccttttggagccagccgccgaaggtgggacagatgattggggtgaagtcgtaacaggg